(19) United States
(12) Patent Application Publication
(10) Pub. No.: US 2026/0059281 A1
(43) Pub. Date: Feb. 26, 2026

(54) MOBILE STATION, TIME SYNCHRONIZATION CONTROL DEVICE, COOPERATIVE OPERATION CONTROL DEVICE, AND COMMUNICATION SYSTEM

(71) Applicant: Mitsubishi Electric Corporation, Tokyo (JP)

(72) Inventor: Akinori TAIRA, Tokyo (JP)

(73) Assignee: Mitsubishi Electric Corporation, Tokyo (JP)

(21) Appl. No.: 19/372,705

(22) Filed: Oct. 29, 2025

Related U.S. Application Data
(63) Continuation of application No. PCT/JP2023/021548, filed on Jun. 9, 2023.

(51) Int. Cl. H04W 4/70; H04W 56/00

(52) U.S. Cl. CPC H04W 4/70; H04W 56/002

(57) ABSTRACT

A mobile station operates as a master mobile station that, in a network that includes a plurality of mobile stations capable of terminal-to-terminal communication, transmits control information by the terminal-to-terminal communication, the control information being generated by a cooperative operation control device that controls a device to be controlled in consideration of a transmission delay time in an information transmission path, and includes: a scheduler unit that determines and changes a radio resource to be used in the terminal-to-terminal communication with a remote mobile station to which the device to be controlled is connected; and a time synchronization unit that checks whether a temporal position of the radio resource has been changed, and notifies a time synchronization control unit, that calculates the transmission delay time, of a change amount of the temporal position in a case where the temporal position has been changed.

### CROSS-REFERENCE TO RELATED APPLICATION

This application is a continuation application of International Application PCT/JP2023/021548, filed on Jun. 9, 2023, and designating the U.S., the entire contents of which are incorporated herein by reference.

### BACKGROUND OF THE INVENTION

### 1. Field of the Invention

The present disclosure relates to a mobile station, a time synchronization control device, and a cooperative operation control device constituting a communication system that performs time synchronization communication, a communication system, a synchronization control method, a control circuit, and a storage medium.

### 2. Description of the Related Art

In recent years, a system has been developed in which a plurality of industrial instruments are connected via a network and operated in cooperation. There are a wide variety of applications used in such a system. For example, a system has been put into practical use in which in a production line of a factory, a plurality of robot arms are connected via a network and time-synchronized on the basis of a command from a specific control device, and perform manufacturing in cooperation. There are many options for such a network, and a plurality of standards are provided under the names of fieldbus, industrial Ethernet (registered trademark), and the like. Cooperation of a plurality of instruments through a network enables an emergency response, sharing of sensor information, and the like to be made, and enables a safe and efficient system to be constructed. Regarding the fieldbus, the industrial Ethernet, and the like, strict time synchronization is required between instruments, and thus design thereof is created so that a delay in signal transmission is minimized, and a standard called time sensitive networking (TSN) that performs time synchronization is widely used.

On the other hand, in order to deal with high-mix low-volume production and to deal with incorporation of not only a production line but also a moving object such as an automatic guided vehicle (AGV) which is an unmanned carrying vehicle into a network, development of time synchronization communication utilizing a wireless communication technology, so-called time sensitive communication (TSC) has started. As an example, there is a fifth generation system (5GS) having been studied in The Third Generation Partnership Project (3GPP (registered trademark)) that standardizes mobile communication systems.

For example, International Publication No. 2021/059538 (WO 2021/059538 A1) discloses a technique of a TSC network including a core device, a base station which is a radio access device, a mobile station which is a terminal device, and a TSN translator. FIG. 2 of International Publication No. 2021/059538 (WO 2021/059538 A1) illustrates a configuration in which an end station which is a network configuration instrument on a TSN working domain outside the core device and an end station connected to the terminal device are connected via the 5GS, and time synchronization communication is performed between both instruments.

In a case where end stations in synchronous operation are connected to each other by the 5GS and other wired network or the like, the 5GS that provides a time synchronization service operates as a virtual TSN bridge when viewed from the end stations. The virtual TSN bridge, which the 5GS is serving as, is expected to have a constant delay time by a TSN translator or the like being provided with a buffer capable of retaining a data signal.

In general terms, a scheduler function unit in a base station belonging to the 5GS allocates radio resources necessary for information transmission so that a propagation delay between nodes constituting a virtual TSN is as constant as possible.

As one of functions of a mobile communication system, a function with which terminal devices directly communicate with each other without via a base station (hereinafter, referred to as terminal-to-terminal communication in some cases) is standardized by 3GPP, and this function is possibly applied to the synchronous operation described above. That is, a case is possible in which a section in which the terminal devices directly communicate with each other is included in a path for transmitting, to a plurality of end stations in synchronous operation, information for realizing the synchronous operation. However, allocation of radio resources to be used in terminal-to-terminal communication is usually performed between the terminal devices, and the scheduler function unit in the base station is not involved therewith. Therefore, it is difficult for the scheduler function unit in the base station to perform control so that the propagation delay between the nodes constituting the virtual TSN is as constant as possible.

### SUMMARY OF THE INVENTION

In order to solve the above-described problems and achieve the object, the present disclosure is a mobile station that operates as a master mobile station that, in a network that includes a plurality of mobile stations capable of terminal-to-terminal communication and realizes time synchronization communication, transmits control information by the terminal-to-terminal communication. The control information is generated by a cooperative operation control device that controls a device to be controlled in consideration of a transmission delay time in an information transmission path to and from the device to be controlled. The mobile station includes: a scheduler unit to determine and change a radio resource to be used in the terminal-to-terminal communication with a remote mobile station that is a mobile station to which the device to be controlled that is a destination of the control information is connected; and a time synchronization unit to check whether a temporal position of the radio resource has been changed when the radio resource has been changed by the scheduler unit, and to notify a time synchronization control unit, that calculates the transmission delay time, of a change amount of the temporal position in a case where the temporal position has been changed.

### BRIEF DESCRIPTION OF THE DRAWINGS

FIG. 1 is a diagram illustrating information used for packet control of time synchronization communication;

FIG. 2 is a diagram illustrating an example of a use case of a communication system according to a first embodiment;

FIG. 3 is a diagram illustrating an exemplary configuration of a network assumed in the first embodiment;

FIG. 4 is a diagram illustrating an exemplary configuration of the communication system according to the first embodiment;

FIG. 5 is a diagram illustrating an example of a frame format used when a mobile station performs terminal-to-terminal communication in 5GS;

FIG. 6 is a diagram illustrating an example of a control information transmission operation in the communication system according to the first embodiment;

FIG. 7 is a diagram illustrating a first example operation of the communication system according to the first embodiment;

FIG. 8 is a diagram illustrating a second example operation of the communication system according to the first embodiment;

FIG. 9 is a flowchart illustrating an example of an operation of the communication system according to the first embodiment;

FIG. 10 is a diagram illustrating an example of a processing circuitry in a case where a processing circuitry that realizes mobile stations constituting the communication system according to the first embodiment is realized by a processor and a memory;

FIG. 11 is a diagram illustrating an example of a processing circuitry in a case where a processing circuitry that realizes mobile stations constituting the communication system according to the first embodiment is constituted by dedicated hardware;

FIG. 12 is a diagram illustrating an exemplary configuration of a communication system according to a second embodiment; and

FIG. 13 is a diagram illustrating an example of a sensor information transmission operation in the communication system according to the second embodiment.

### DETAILED DESCRIPTION OF THE PREFERRED EMBODIMENTS

Hereinafter, a mobile station, a time synchronization control device, a cooperative operation control device, a communication system, a synchronization control method, a control circuit, and a storage medium according to each embodiment of the present disclosure will be described in detail with reference to the drawings. First Embodiment.

First, as a comparative example, a method will be described in which synchronization control is realized via a network that does not include a section in which terminal devices directly communicate with each other.

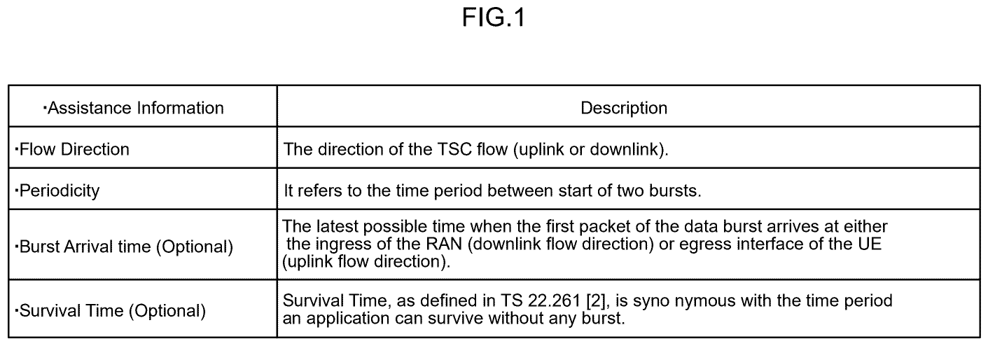

As described above, in 5GS that provides a time synchronization service, a scheduler function unit in a base station allocates radio resources so that propagation delay between nodes is as constant as possible. However, there is a problem that due to an influence of a frequency offset between a grand master clock on a TSN working domain to which an end station belongs and a clock source uniquely possessed by the 5GS, a traffic situation of another user to which the 5GS simultaneously provides a service, or the like, propagation delays do not match, for example, an arrival timing of an information packet from the end station and an allocation timing of a radio resource do not match. In order to solve this problem, a mechanism for adjusting a timing error is also introduced. For example, in Table 5.27.2-1 of 3GPP TS23.501 V17.2.0 (2021-09), time sensitive communication assistance information (TSCAI) illustrated in FIG. 1 is defined as information for controlling a packet of TSC. In the system of the comparative example that realizes the time synchronization service, a transmission delay time is shortened by designating, by the TSCAI, a period of the information packet transmitted by the end station and an arrival timing thereof at the 5GS. Some information of the TSCAI is transferred from an access and mobility management function (AMF) which is a part of core functions to (R) AN and user equipment (UE), and is used for scheduling wireless transmission. An example of use of the TSCAI for scheduling (R) AN is also disclosed in paragraph 0058 of International Publication No. 2021/059538 (WO 2021/059538 A1) described above. The UE is also referred to as a terminal device or a mobile station.

The above-described method for shortening the delay time using the TSCAI assumes the existence of a core functional unit of the 5GS, and thus cannot be applied to a system including a section in which terminal devices directly communicate with each other. Therefore, it is desired to realize a method that does not require the core functional unit of the 5GS.

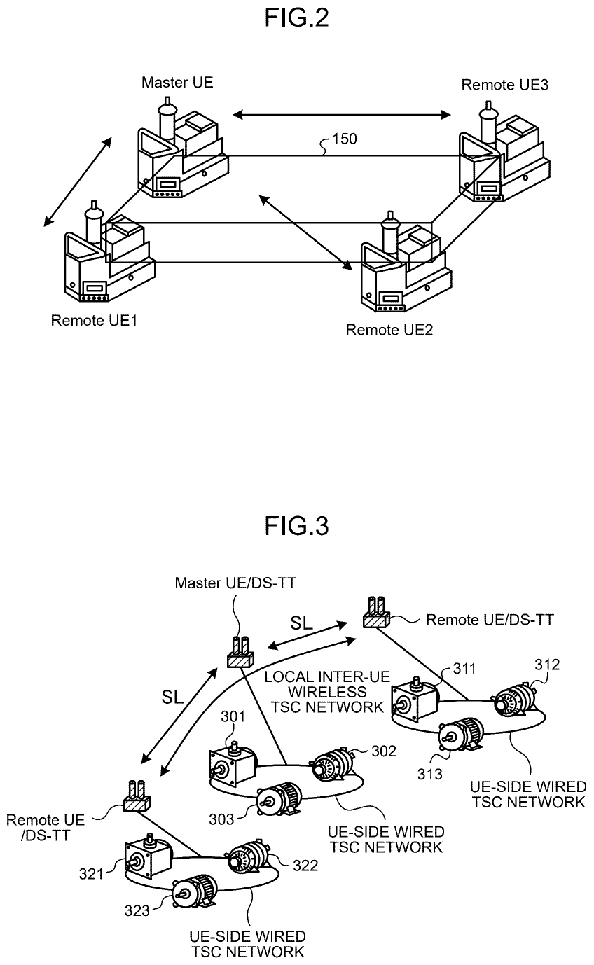

Next, a communication system according to the present embodiment will be described. FIG. 2 is a diagram illustrating an example of a use case of a communication system according to a first embodiment. FIG. 2 illustrates an example of a cooperative conveyance device that conveys one load 150 by a plurality of driving devices. In this use case, respective end stations under the control of four UEs are connected to motors each constituting a drive device, and control a moving speed and a moving direction. In that case, in order to convey the load 150 well, it is necessary to strictly match the speeds and directions of the four drive devices, and communication with a lower delay is required. In other words, wiring is replaced with a wireless line in an application such as servo control that is conventionally connected directly by wire and controlled with a fixed delay time. In the present embodiment, a wireless line to be replaced with wiring is realized by terminal-to-terminal communication.

FIG. 3 is a diagram illustrating an exemplary configuration of a network assumed in the first embodiment. The network assumed in the present embodiment includes a plurality of UEs and a direct communication path between the UEs which is a section in which terminal-to-terminal communication is performed. This network is referred to as a local inter-UE wireless TSC network. For example, in the use case illustrated in FIG. 2, one of the UEs serves as a master mobile station (master UE), and transmits control information to instruments to be controlled (also referred to as devices to be controlled in some cases) 301 to 303, 311 to 313, and 321 to 323 under control of the master UE and other remote mobile stations (remote UEs) to realize a desired operation in the entire TSC network. In 3GPP, a link in terminal-to-terminal communication is called sidelink (SL). In FIG. 3, double arrows described as “SL” each indicate the link in terminal-to-terminal communication.

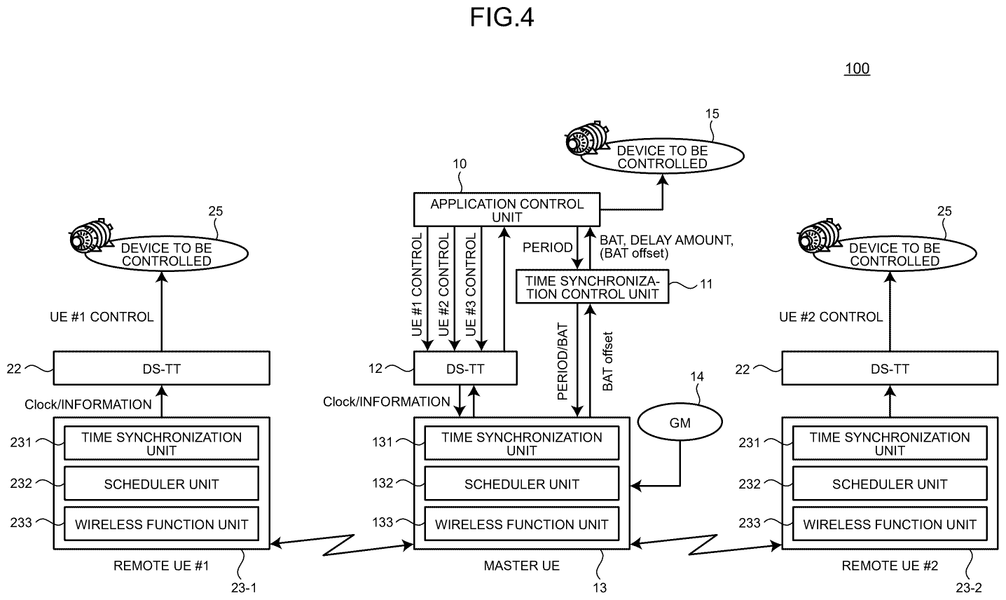

FIG. 4 is a diagram illustrating an exemplary configuration of a communication system 100 according to the first embodiment. In FIG. 4, each mobile station is described as “UE”. The same applies to the figures to be used in the following description.

The communication system 100 according to the present embodiment includes one master mobile station 13 and a plurality of remote mobile stations 23 (remote mobile stations 23-1 and 23-2 are illustrated in FIG. 4). A network including the master mobile station 13 and the plurality of remote mobile stations 23 realizes time synchronization communication. The master mobile station 13 and the remote mobile stations 23 each have a terminal-to-terminal communication function, and can directly communicate with other mobile stations without via the base station. In the communication system 100, the master mobile station 13 directly communicates with each of the remote mobile stations 23-1 and 23-2.

To the master mobile station 13, an application control unit 10 is connected via a device side Tsn translator (DS-TT) 12, the application control unit 10 controlling an application to be realized by a time synchronization network which is a network formed by the master mobile station 13 and the remote mobile stations 23-1 and 23-2. The DS-TT is defined in the above-described document “3GPP TS23.501 V17.2.0 (2021-09)”, and performs a process for realizing a time synchronization function. To the application control unit 10, a device to be controlled 15 that can be controlled without via a wireless line is connected.

The master mobile station 13 includes a time synchronization unit 131 that controls a TSC function as a mobile station, a scheduler unit 132 that determines a radio resource to be used in terminal-to-terminal communication, and a wireless function unit 133 that performs a transmission/reception process of a wireless signal. A grand master clock (GM) 14 that provides a reference clock for the time synchronization network is connected to the master mobile station 13. Note that the reference clock is not necessarily an independent functional block, and time information reproduced by a GPS receiver or time information generated from an oscillator built in the mobile station may be used.

A time synchronization control unit 11 that controls the TSC function of the entire system including the master mobile station 13 and the plurality of remote mobile stations 23 is provided between the master mobile station 13 and the application control unit 10.

The remote mobile stations 23-1 and 23-2 also have the same configuration as the master mobile station 13, but in FIG. 4, corresponding components are denoted by different reference numerals. The remote mobile stations 23-1 and 23-2 each include a time synchronization unit 231 having a function similar to that of the time synchronization unit 131 of the master mobile station 13, a scheduler unit 232 having a function similar to that of the scheduler unit 132 of the master mobile station 13, and a wireless function unit 233 having a function similar to that of the wireless function unit 133 of the master mobile station 13. The remote mobile stations 23 are each connected to a device to be controlled 25 via a DS-TT 22 that performs a process similar to that of the DS-TT 12 described above. In 3GPP, a wireless interface on the SL is referred to as a PC5.

The application control unit 10 and the time synchronization control unit 11 are provided, for example, in a control device that controls the operations of the devices to be controlled 15 and 25.

Note that FIG. 4 illustrates an example in which the device to be controlled is not connected to the master mobile station 13, but, similarly to the example illustrated in FIG. 3, a configuration may be employed in which the device to be controlled is connected to the master mobile station 13.

Next, an operation of the communication system 100 according to the first embodiment will be described. The application control unit 10 generates control information for operating a desired application. The cooperative conveyance device illustrated in FIG. 2 will be taken as an example. In this example, the application control unit 10 generates control information such as speed, direction, and torque for the device to be controlled 15 under the control thereof and the devices to be controlled 25 each under the control of one of the plurality of remote mobile stations 23. This control information can be variously expressed, and for example, it is also possible to perform a notification of angle information of each motor at a specific time, and the content of the control information is not limited. In the present embodiment, an object is to fix a delay time of the control information which is a time required for the control information to arrive at the devices to be controlled 15 and 25 after the application control unit 10 outputs the control information. Therefore, the application control unit 10 generates and outputs the control information in consideration of the delay time of the control information. In order to transmit the control information from the application control unit 10 to the devices to be controlled 25 under the control of the remote mobile stations 23, a specific communication session is set, radio resources are allocated, and the control information is transmitted.

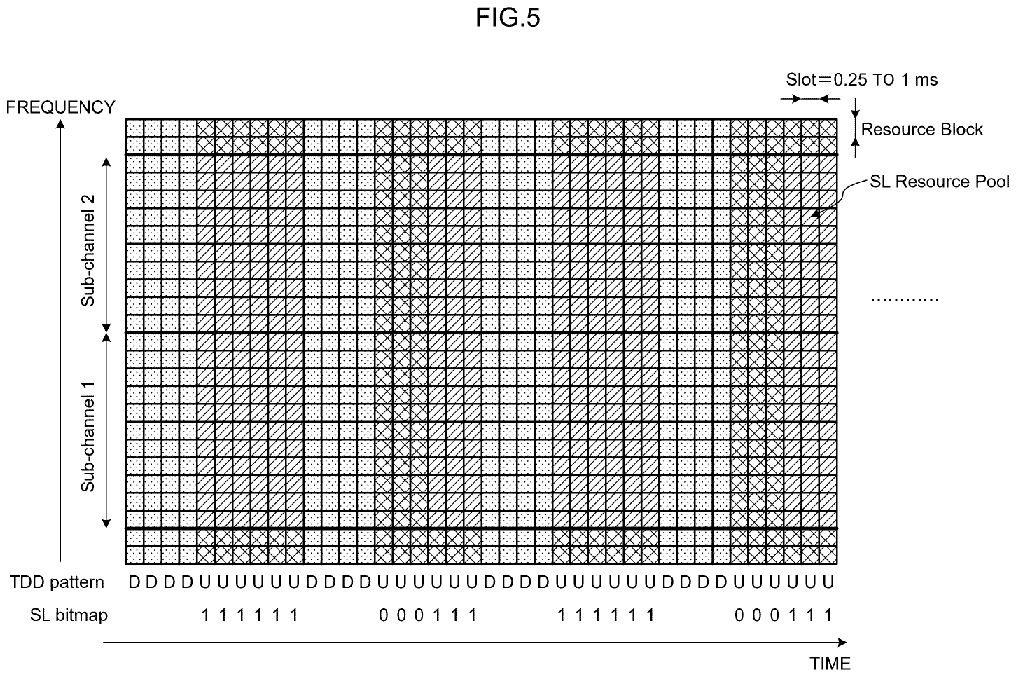

FIG. 5 is a diagram illustrating an example of a frame format used when a mobile station performs terminal-to-terminal communication in the 5GS. A part of uplink (UL) resources ensured for transmission from a mobile station to a base station in communication between the mobile station and the base station is allocated to the SL. A resource that can be allocated to the SL is a region (or an area) specified in a time and frequency range referred to as an SL resource pool. This region may be disposed considerably discretely in terms of time.

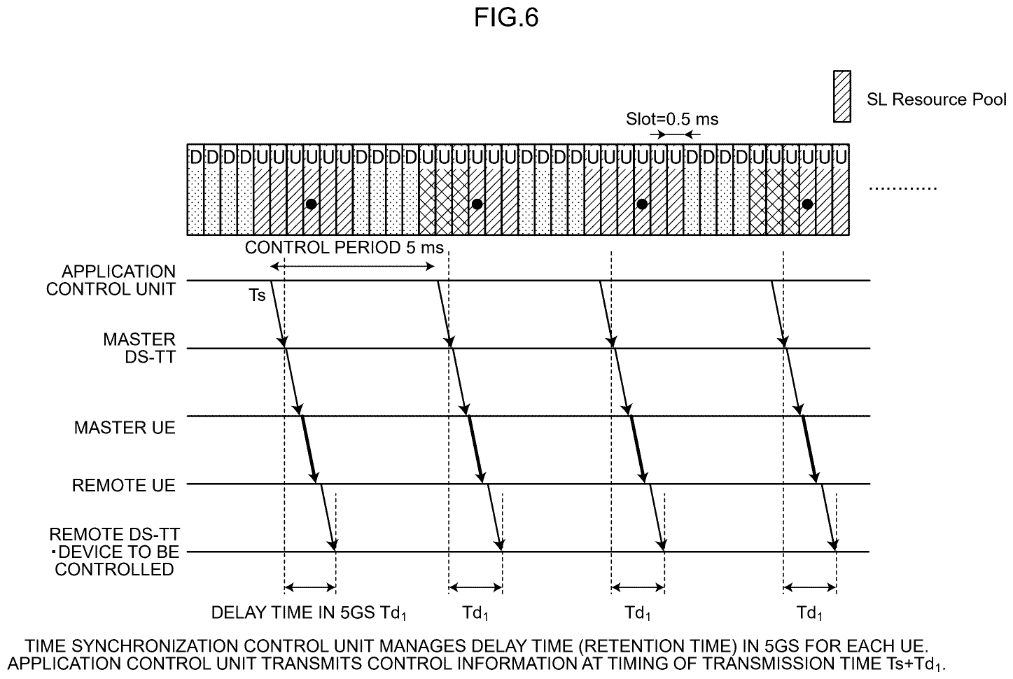

FIG. 6 is a diagram illustrating an example of a control information transmission operation in the communication system 100 according to the first embodiment. FIG. 6 illustrates an example in which control information is transmitted from the application control unit 10 to the device to be controlled 25 under the control of the remote mobile station 23 with a control period of 5 ms. Vertically long rectangles on an upper stage each indicate a resource for wireless communication. A reference sign “U” represents a UL resource, and a reference sign “D” represents a downlink (DL) resource. In addition, a filled-circle symbol “•” indicates that it is a resource allocated to terminal-to-terminal communication.

For an application that performs periodic control such as that illustrated in FIG. 6, resource allocation called semi-persistent scheduling is performed. The scheduler unit 132 of the master mobile station 13 continuously ensures radio resources with a period of 5 ms as illustrated in FIG. 6. Specifically, the application control unit 10 issues an information transmission request with a period of 5 ms to the time synchronization control unit 11, and the time synchronization control unit 11 instructs the time synchronization unit 131 of the master mobile station 13 to ensure a resource with a period of 5 ms for terminal-to-terminal communication with the remote mobile stations 23. The time synchronization unit 131 instructs the scheduler unit 132 to ensure an appropriate resource in consideration of a conflict with a communication resource to be used in another session. In FIG. 6, a master DS-TT corresponds to the DS-TT 12 illustrated in FIG. 4, and a remote DS-TT corresponds to the DS-TT 22 illustrated in FIG. 4.

In a case of the control information transmission operation in the example illustrated in FIG. 6, the application control unit 10 generates control information at time Ts, and transmits the control information to the device to be controlled 25 via the master DS-TT (DS-TT 12), the master UE (master mobile station 13), the remote UE (remote mobile station 23), and the remote DS-TT (DS-TT 22). Note that time Ts is assumed to be a relative time from a head timing of a 5GS radio frame or a relative time from any timing corresponding to the 5GS radio frame, but may be an absolute time outside the 5GS such as world standard time. Assuming that a transmission delay time in the 5GS is Td₁, the application control unit generates and transmits, at time Ts, control information of the device to be controlled 25 at a time point of time Ts+Td₁. In the example illustrated in FIG. 6, the next information transmission timing is Ts+5 ms. Since the transmission delay time Td₁ in the 5GS differs for each session, the application control unit 10 generates and transmits control information at different timings for each session. In a case where there are a plurality of devices to be controlled 25 under the control of one remote mobile station 23, a plurality of sessions may be created between the master mobile station 13 and the remote mobile station 23. At that time, the control information is generated and transmitted at different timings for each of the devices to be controlled 25 even under the control of the same remote mobile station 23.

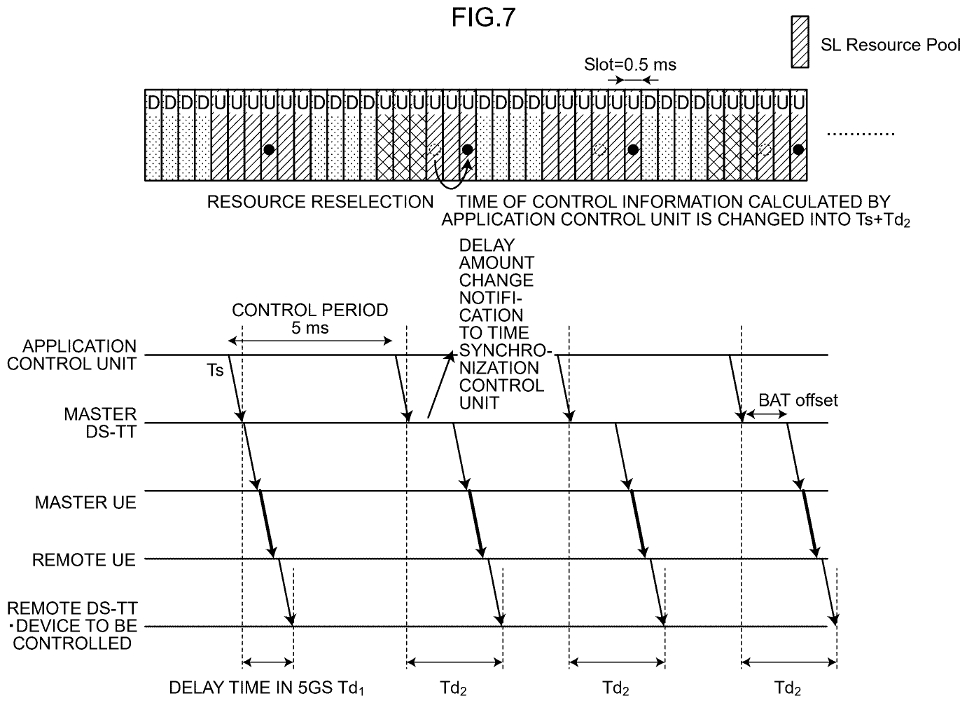

Here, according to a 5GS standard, it is required to periodically change a position where the SL resource is ensured for terminal-to-terminal communication for a specific session. This is an operation called “resource reselection”. At the time of resource reselection, there is no problem in a case where a radio resource can be ensured at a different frequency position in a slot at the same timing, but there is also a case where a radio resource is ensured in a different slot. FIG. 7 is a diagram illustrating a first example operation of the communication system 100 according to the first embodiment. FIG. 7 illustrates a control information transmission operation in a case where resource reselection is performed in terminal-to-terminal communication. FIG. 7 illustrates an example operation in a case where a slot at a timing different from a previous timing is ensured in resource reselection, specifically, an operation example in a case where the position of a radio resource to be ensured is shifted backward by two slots. In this example, the timing of the radio resource to be ensured for the control information transmission is delayed by 1 ms relative to a transmission timing of application control. Variation in the delay time is absorbed to some extent by buffering of the DS-TT 22, but in a case where a buffer amount is reduced in order to reduce the delay, the transmission delay time in the 5GS is changed from Td₁ to Td₂. This causes inconsistency in the control information.

Processes for preventing the occurrence of such a problem are performed in the communication system 100 according to the present embodiment. Specifically, in the communication system 100, the time synchronization unit 131 detects a change in a temporal position of the radio resource due to resource reselection, and notifies the time synchronization control unit 11 of the difference, that is, a change amount as a burst arrival time (BAT) offset, for example. The time synchronization control unit 11 calculates a new transmission delay time Td₂ in the 5GS on the basis of offset information which is BAT offset that the time synchronization unit 131 has notified the time synchronization control unit 11 of, and notifies the application control unit 10 of all or part of information on current BAT (=Ts), the transmission delay time in the 5GS, and the BAT offset. Note that the transmission delay time Td₂ may be calculated by the time synchronization unit 131. In that case, the time synchronization unit 131 notifies the time synchronization control unit 11 of the new transmission delay time Td₂ together with the BAT offset.

When receiving the notification of the information from the time synchronization control unit 11 that has calculated the new transmission delay time Td₂ in the 5GS, the application control unit 10 performs any one of the following two types of countermeasures.

A first countermeasure is to change an assumed transmission delay time in the 5GS. In the example illustrated in FIG. 7, this countermeasure is performed. Specifically, when receiving a notification of the BAT offset and the transmission delay time Td₂ from the time synchronization control unit 11, the application control unit 10 changes a transmission delay time in communication with the device to be controlled 25 under the control of the remote mobile station 23 into Td₂. That is, the application control unit 10 changes the transmission delay time to the device to be controlled 25 to be used when generating the control information for the device to be controlled 25. Thereafter, the application control unit 10 generates control information at a time Ts+Td₂ and continues the control of the system.

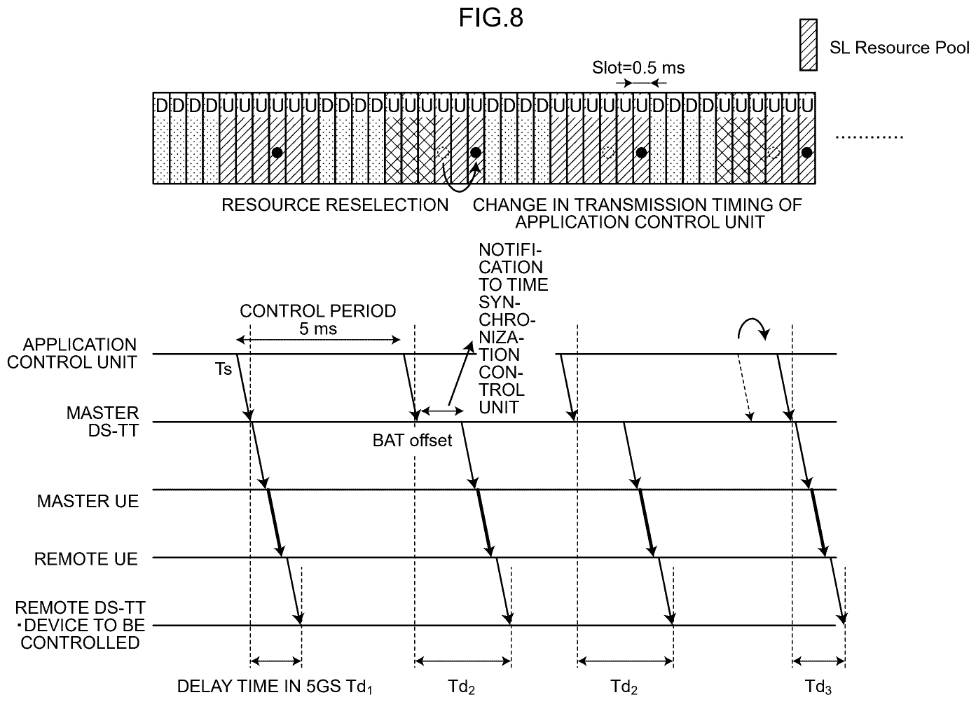

A second countermeasure is to change Ts which is a timing at which the control information is transmitted from the application control unit 10 to the DS-TT 12. Of course, it is desirable that the transmission delay time from the application control unit 10 to the device to be controlled 25 be short. The second countermeasure will be described with reference to FIG. 8.

FIG. 8 is a diagram illustrating a second example operation of the communication system 100 according to the first embodiment. Similarly to FIG. 7, FIG. 8 illustrates a control information transmission operation in a case where resource reselection is performed in terminal-to-terminal communication. Similarly to FIG. 7, FIG. 8 illustrates an example of a case where the position of a radio resource to be ensured in resource reselection is shifted backward by two slots from a previous position.

When a transmission timing on a wireless line is delayed by 1 ms due to resource reselection, the application control unit 10 delays BAT (=Ts) by 1 ms to minimize the transmission delay time. Assuming that a new transmission delay time in the 5GS is Td₃, the application control unit 10 generates and transmits control information at a time point of Ts+Td₃. In general, Td₁ and Td₃ are considered to have similar time lengths, but these time lengths are not necessarily the same.

Note that all the functional units including the application control unit 10 and the time synchronization control unit 11 that constitute the system receive clock information synchronized with the GM 14 and are time-synchronized. This is not necessarily limited to driving by the same clock, and a configuration may be employed in which a frequency difference between a local clock and a GM clock is managed and corrected to thereby realize the time synchronization. The clock information is delivered by using precision time protocol (PTP), an access stratum timing distribution system (ASTI), or the like.

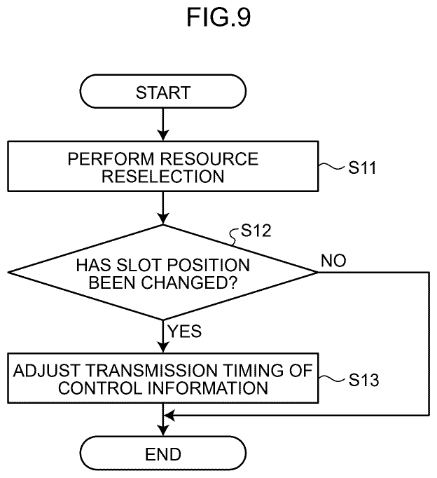

FIG. 9 is a flowchart illustrating an example of an operation of the communication system 100 according to the first embodiment. The flowchart in FIG. 9 illustrates an operation in a case where resource reselection is performed in terminal-to-terminal communication.

In the communication system 100, first, the scheduler unit 132 of the master mobile station 13 performs resource reselection (step S11). Next, the time synchronization unit 131 checks whether a slot position has been changed, that is, whether a temporal position of a radio resource has been changed when performing the resource reselection (step S12). If the slot position has not been changed (step S12: No), the operation is ended. If the slot position has been changed (step S12: Yes), the application control unit 10 adjusts the transmission timing of the control information (step S13). In step S13, the transmission timing is adjusted by using the method in which the transmission delay time Td assumed in the 5GS is changed (the method illustrated in FIG. 7) or the method in which the BAT is changed (the method illustrated in FIG. 8) described above.

As described above, in the communication system 100 according to the present embodiment, the master mobile station 13 checks whether the slot position has been changed in a case where resource reselection for terminal-to-terminal communication has been performed, and changes the transmission delay time assumed in the 5GS or the BAT if the slot position has been changed. Consequently, even in a case where the slot position has been changed due to resource reselection for terminal-to-terminal communication in a network having a configuration including a section to which terminal-to-terminal communication is applied, it is possible to realize synchronization control of a plurality of devices to be controlled.

Note that the application control unit 10 and the time synchronization control unit 11 may be provided in one device that controls a plurality of devices to be controlled by using time synchronization communication, or may be provided in different devices. For example, the application control unit 10 may be provided in a cooperative operation control device, and the time synchronization control unit 11 may be provided in a time synchronization control device. Alternatively, a configuration may be employed in which the time synchronization unit 131 of the master mobile station 13 has the function of the time synchronization control unit 11, that is, the time synchronization unit 131 also operates as the time synchronization control unit 11.

Next, a hardware configuration of each device of the communication system 100 will be described. The wireless function unit 133 of the master mobile station 13 and the wireless function units 233 of the remote mobile stations 23-1 and 23-2 are each realized by, for example, a transceiver. The time synchronization unit 131 and the scheduler unit 132 of the master mobile station 13 and the time synchronization units 231 and the scheduler units 232 of the remote mobile stations 23-1 and 23-2 are each realized by a processing circuitry. The processing circuitry may be a processor that executes a program stored in a memory and the memory, or may be dedicated hardware. The processing circuitry is also referred to as a control circuit.

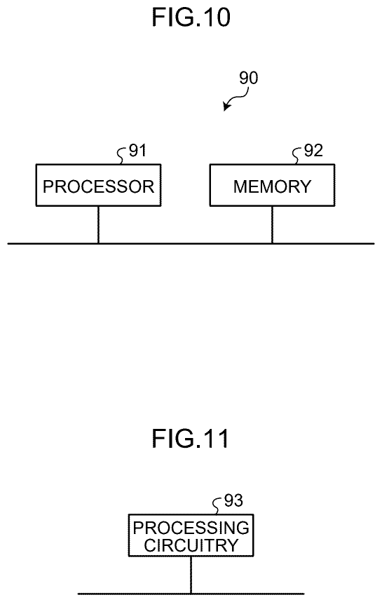

FIG. 10 is a diagram illustrating an example of a processing circuitry 90 in a case where a processing circuitry that realizes mobile stations (the master mobile station 13, and the remote mobile stations 23-1 and 23-2) constituting the communication system 100 according to the first embodiment is realized by a processor 91 and a memory 92. The processing circuitry 90 illustrated in FIG. 10 includes the processor 91 and the memory 92. Each function of the processing circuitry 90 is realized by software, firmware, or a combination of software and firmware. The software or the firmware is described as a program and stored in the memory 92. In the processing circuitry 90, the processor 91 reads and executes the program stored in the memory 92, thereby realizing the functions. That is, the processing circuitry 90 includes the memory 92 for storing a program with which a process of each mobile station constituting the communication system 100 is executed as a result. It can also be said that this program is a program for causing the mobile station to execute the functions realized by the processing circuitry 90. This program may be provided by a storage medium having the program stored therein, or may be provided by other means such as a communication medium.

The processor 91 is, for example, a central processing unit (CPU), a processing device, an arithmetic device, a microprocessor, a microcomputer, or a digital signal processor (DSP). The memory 92 is, for example, a nonvolatile or volatile semiconductor memory such as a random access memory (RAM), a read only memory (ROM), a flash memory, an erasable programmable ROM (EPROM), or an electrically EPROM (EEPROM (registered trademark)).

FIG. 11 is a diagram illustrating an example of a processing circuitry 93 in a case where a processing circuitry that realizes mobile stations constituting the communication system 100 according to the first embodiment is constituted by dedicated hardware. The processing circuitry 93 illustrated in FIG. 11 corresponds to, for example, a single circuit, a composite circuit, a programmed processor, a parallel programmed processor, an application specific integrated circuit (ASIC), a field programmable gate array (FPGA), or a combination thereof. A part of the processing circuitry may be realized by dedicated hardware and another part thereof may be realized by software or firmware. Thus, the processing circuitry can realize the above-described functions by dedicated hardware, software, firmware, or a combination thereof.

### Second Embodiment

In a control system application such as that illustrated in FIG. 2, it is generally necessary not only to unilaterally transmit control information but also to acquire a state of a device to be controlled by a sensor and feed back the state to the control device. Therefore, the present embodiment discloses a communication system that realizes feedback from a device to be controlled.

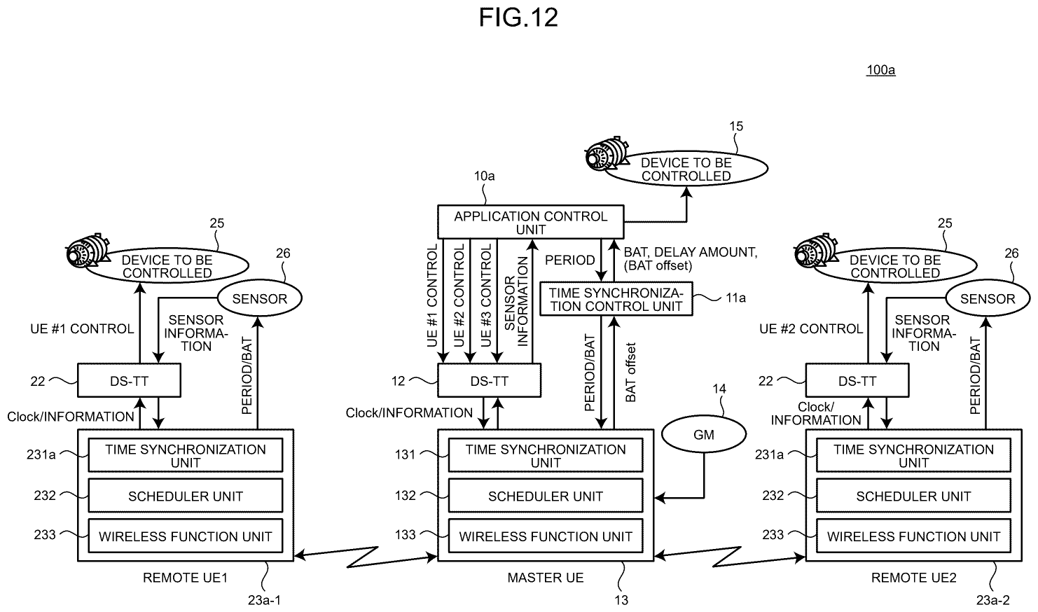

FIG. 12 is a diagram illustrating an exemplary configuration of a communication system 100a according to a second embodiment. In FIG. 12, components common to the communication system 100 according to the first embodiment illustrated in FIG. 4 are denoted by the same reference numerals as those in the communication system 100.

Explanations on the components denoted by the same reference numerals as those in the communication system 100 are omitted.

The communication system 100a includes the master mobile station 13 and a plurality of remote mobile stations 23a (remote mobile stations 23a-1 and 23a-2 are illustrated in FIG. 12). The remote mobile stations 23a each include a time synchronization unit 231a, the scheduler unit 232, and the wireless function unit 233. In addition, the communication system 100a includes an application control unit 10a and a time synchronization control unit 11a.

A sensor 26 is attached to each of the devices to be controlled 25. Sensor information output by each sensor 26 is transmitted to the application control unit 10a via the DS-TT 22, the remote mobile station 23a, the master mobile station 13, and the DS-TT 12.

Next, an operation of the communication system 100a according to the second embodiment will be described. An operation of transmitting control information from the master mobile station 13 to each remote mobile station 23a in the communication system 100a is similar to that in the communication system 100 according to the first embodiment, and thus will not be described here.

Each sensor 26 has a role of measuring the state of the device to be controlled 25 and notifying the application control unit 10a of the state. Here, in a case where the sensor 26 is a sophisticated sensor, the sensor 26 creates sensor information by adding a time stamp of a measurement time to measurement information, and transmits the sensor information. In that case, the application control unit 10a can adjust a processing timing and the like on the basis of the time stamp included in the sensor information. On the other hand, in many conventional sensors, all information transmission paths are connected by wire, and a process is performed on the assumption of a fixed delay time. In addition, a case is also assumed where a time stamp cannot be newly added due to a transmission format. Therefore, in the present embodiment, a description will be given for the communication system 100a that does not require a time stamp, that is, the communication system 100a that enables, without using a time stamp, information transmitted from the sensor 26 to the application control unit 10a to be used for synchronization control of the device to be controlled 25.

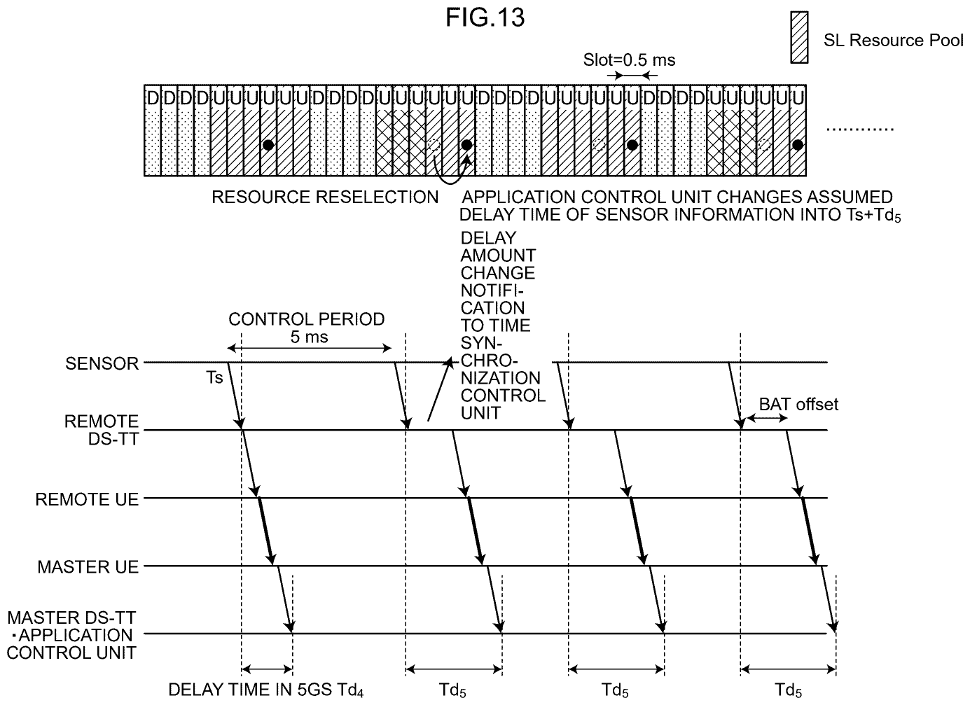

FIG. 13 is a diagram illustrating an example of a sensor information transmission operation in the communication system 100a according to the second embodiment. FIG. 13 illustrates an example of a timing in a case where information is transmitted from the sensor 26 to the application control unit 10a. In the sensor 26, information is generated every 5 ms.

In the example illustrated in FIG. 13, the sensor information is generated at relative time Ts from some reference timing of a radio frame, and the information is transmitted to the application control unit 10a via the DS-TT 22, the remote mobile station 23a, the master mobile station 13, and the DS-TT 12. The arrival time of the sensor information at the application control unit 10a is a time obtained by adding an assumed transmission delay time in the 5GS to the relative time Ts of the sensor information. At that time, if the transmission delay time in the 5GS is Td₄, the application control unit 10a can recognize that the received sensor information is sensor information at a time point of Ts from information on the transmission delay time Td₄ provided from the time synchronization control unit 11a. In a case where a radio resource to be ensured by the remote mobile station 23a is shifted backward by two slots (=1 ms) in resource reselection, the time synchronization unit 231a detects the shift in the slot position and notifies the time synchronization control unit 11a of a difference thereof as, for example, BAT offset. The time synchronization control unit 11a calculates a new transmission delay time Td₅ in the 5GS from this information, and notifies the application control unit 10a of all or a part of information on current BAT (=Ts), the transmission delay time in the 5GS, and the BAT offset. Note that the transmission delay time Td₅ may be calculated by the time synchronization unit 231a. In that case, the time synchronization control unit 11a is notified of the new transmission delay time Td₅ together with the BAT offset.

The application control unit 10a receives the transmission delay time Td₅ from the time synchronization control unit 11a and calculates time Ts at which the sensor information is generated. That is, if the sensor information is transferred from the DS-TT 12 to the application control unit 10a at time Tr, the application control unit 10a can estimate a generation time of the sensor information by Ts=Tr-Td₅. Note that Ts may be directly transferred from the time synchronization control unit 11a to the application control unit 10a.

In general, the sensor information obtained by the application control unit 10a is also desired to be as new information as possible. That is, it is desirable to change a generation timing of the sensor information and minimize the BAT offset. Therefore, the application control unit 10a or the time synchronization control unit 11a notifies the sensor 26 of a new transmission timing (BAT) of the sensor information at which the BAT offset can be minimized. The sensor 26 calculates and updates the transmission timing Ts from the sensor 26 with the BAT as reference. The time synchronization control unit 11a calculates a delay time in the 5GS from the DS-TT 22 to the DS-TT 12 at the new transmission timing Ts, and notifies the application control unit 10a of the delay time. The application control unit 10a that has received the notification changes the delay time in the 5GS to be used in a process of generating control information for the device to be controlled 25 into the delay time in the 5GS that the time synchronization control unit 11a has notified the application control unit 10a of.

As described above, in the communication system 100a according to the present embodiment, the application control unit 10a acquires the transmission delay time assumed in the 5GS from the time synchronization control unit 11a, and calculates a time when the sensor information acquired from each of the sensors 26 connected to the remote mobile stations 23a has been transmitted on the basis of the acquired transmission delay time. In a case where the resource reselection for terminal-to-terminal communication has been performed, each remote mobile station 23a checks whether the slot position has been changed. If the slot position has been changed, the time synchronization control unit 11a changes the transmission delay time assumed in the 5GS, and the application control unit 10a calculates a time when the sensor information has been transmitted by using the changed transmission delay time. In addition, the time synchronization control unit 11a determines a new transmission timing of the sensor information and notifies each sensor 26 of the new transmission timing. The sensor 26 changes the transmission timing of the sensor information into the transmission timing in the notification. Consequently, even in a case where a slot position has been changed due to resource reselection for terminal-to-terminal communication in a network configured to include a section to which terminal-to-terminal communication is applied, the application control unit 10a can know a time when the sensor information has been transmitted from each remote mobile station 23a to the application control unit 10a, and the synchronization control of the plurality of devices to be controlled can be realized.

The mobile station according to the present disclosure achieves an effect that it is possible to realize synchronization control of a plurality of instruments connected via a network including a section in which terminal devices directly communicate with each other.

The configurations described in the above embodiments are merely examples and can be combined with other known technology, the embodiments can be combined with each other, and part of the configurations can be omitted or modified without departing from the gist thereof.

What is claimed is:

1. A mobile station that operates as a master mobile station that, in a network that includes a plurality of mobile stations capable of terminal-to-terminal communication and realizes time synchronization communication, transmits control information by the terminal-to-terminal communication, the control information being generated by a cooperative operation control device that controls a device to be controlled in consideration of a transmission delay time in an information transmission path to and from the device to be controlled, the mobile station comprising:
scheduler circuitry to determine and change a radio resource to be used in the terminal-to-terminal communication with a remote mobile station that is a mobile station to which the device to be controlled that is a destination of the control information is connected; and
time synchronization circuitry to check whether a temporal position of the radio resource has been changed when the radio resource has been changed by the scheduler circuitry, and to notify time synchronization control circuitry, that calculates the transmission delay time, of a change amount of the temporal position in a case where the temporal position has been changed.

2. A mobile station that operates as a remote mobile station that, in a network that includes a plurality of mobile stations capable of terminal-to-terminal communication and realizes time synchronization communication, is connected to a device to be controlled and receives control information by the terminal-to-terminal communication, the control information being generated by a cooperative operation control device that controls the device to be controlled in consideration of a transmission delay time in an information transmission path to and from the device to be controlled, the mobile station comprising:
scheduler circuitry to determine and change a radio resource to be used in the terminal-to-terminal communication when information is transmitted to the cooperative operation control device; and
time synchronization circuitry to check whether a temporal position of the radio resource has been changed when the radio resource has been changed by the scheduler circuitry, and to notify time synchronization control circuitry, that calculates the transmission delay time, of a change amount of the temporal position in a case where the temporal position has been changed.

3. A time synchronization control device that constitutes a communication system together with the mobile station according to claim 1 and operates as the time synchronization control circuitry, wherein
in a case of receiving a notification of the change amount from the time synchronization circuitry, the time synchronization control device calculates the transmission delay time on a basis of the change amount, and notifies the cooperative operation control device of the calculated transmission delay time and the change amount.

4. The cooperative operation control device that constitutes a communication system together with the mobile station according to claim 2, wherein
in a case of receiving a notification of the transmission delay time calculated on a basis of the change amount from the time synchronization control circuitry, the cooperative operation control device changes the transmission delay time in the notification so as to be used in a generation process of the control information.

5. A communication system that forms a network that includes a plurality of mobile stations capable of terminal-to-terminal communication and realizes time synchronization communication, the communication system including:
a master mobile station being one of the mobile stations to transmit, by the terminal-to-terminal communication, control information for controlling a device to be controlled;
a plurality of remote mobile stations each being a mobile station to which the device to be controlled that is a destination of the control information is connected;
application control circuitry to generate the control information and to transmit the control information to the device to be controlled via the master mobile station and each of the remote mobile stations; and
time synchronization control circuitry to calculate a transmission delay time when the control information is transmitted from the application control circuitry to the device to be controlled, wherein
the master mobile station determines and changes a radio resource to be used in the terminal-to-terminal communication with each of the remote mobile stations to which the device to be controlled that is a destination of the control information is connected, and in a case where a temporal position of the radio resource has been changed in a change process of the radio resource, the master mobile station notifies the time synchronization control circuitry of a change amount of the temporal position,
when receiving a notification of the change amount from the master mobile station, the time synchronization control circuitry recalculates the transmission delay time on a basis of the change amount in the notification and notifies the application control circuitry of the recalculated transmission delay time, and
the application control circuitry changes a transmission delay time to be used when generating the control information into the transmission delay time that is notified by the time synchronization control circuitry, or changes a timing of transmitting the control information on a basis of the transmission delay time that is notified by the time synchronization control circuitry.

6. The communication system according to claim 5, wherein
the network is a star topology network centered on the master mobile station.
